(19) United States
(12) Patent Application Publication
(10) Pub. No.: US 2016/0376170 A1
(43) Pub. Date: Dec. 29, 2016

(54) LIGHT GUIDING MEMBER AND LIGHT EMITTING ARRANGEMENT

(71) Applicant: KONINKLIJKE PHILIPS N.V., Eindhoven (NL)

(72) Inventors: MARIUS GABRIEL IVAN, EINDHOVEN (NL); JIANG-HONG YU, EINDHOVEN (NL)

(21) Appl. No.: 14/901,853

(22) PCT Filed: Jun. 25, 2014
(86) PCT No.: PCT/EP2014/063356

§ 371 Date: Dec. 29, 2015

(30) Foreign Application Priority Data
Jul. 3, 2013 (EP) 13174936.8

(51) Int. Cl. C02F 1/32; G02B 5/02; F21V 8/00; B29D 11/00; B01J 19/12

(52) U.S. Cl. CPC C02F 1/325; B29D 11/00721; B01J 19/123; G02B 6/0005; G02B 5/0242; C02F 2303/04; C02F 2201/32; B29K 2105/16

(57) ABSTRACT

A light-guiding member comprises a light transmissive, solid carrier material, and scattering particles of boron nitride dispersed in said carrier material. The light-guiding member is employed in a light emitting arrangement comprising a solid state light emitting element arranged to emit light into the light guiding member via a light input surface. Light can be guided within the light-guiding member to be outcoupled via at least part of a light output surface. The light emitting arrangement provides a simple and efficient illumination device for UV disinfection of water and other fluids.

### FIELD OF THE INVENTION

The present invention relates to a light guiding member for use with solid-state light emitting elements, in particular UV light emitting diodes, to methods of producing such a light-guiding member, and to a light emitting arrangement including such a light guiding member.

### BACKGROUND OF THE INVENTION

Ultraviolet (UV) light has been used for many decades for disinfection of objects, surfaces and drinking water. UV light, in particular UV-C or deep UV light, can degrade organic and inorganic chemicals and destroy the DNA of microorganisms such as bacteria, fungi and viruses. Using UV light for water disinfection is advantageous since it is environmentally friendly, does not require addition of chemicals for disinfection such as in the case of chlorination, and may be applied in small/portable devices at the point of use as well as in large scale water treatment plants.

In particular for disinfection of liquids, such as water, various technical solutions have been proposed. One example includes Steripen® a portable gas discharge UV light source for water purification. A similar solution using LEDs is described in U.S. Pat. No. 6,579,495 B1, where UV LEDs are embedded in a portable exposure unit for water disinfection. However, a drawback of these technologies is that they require immersion of the light source into the water, and thus the devices must be adequately protected and liquid-tight. Moreover, with mercury-vapor gas discharge lamps there is a risk of hazardous gas leakage due to breaking of the glass tube enclosing the discharge gas.

Another solution using solid-state light emitting devices, in particular light emitting diodes (LEDs) is presented in KR20120037140 A, which discloses a UV emitting LED optically coupled to a light guiding rod, which can be immersed into a water container. The light guiding rod can be molded and may comprise metal powder. Advantageously, the LED need not be immersed into the water, which reduces the risk for shorts. However, the device proposed in KR20120037140 A suffers from low efficiency with respect to guiding, scattering and/or extraction of germicidal UV light.

Hence in spite of the solution proposed in KR20120037140 A, there is a need in the art for improved solutions for UV light sources suitable for water disinfection.

### SUMMARY OF THE INVENTION

It is an object of the present invention to overcome this problem, and to provide a means for simple and efficient UV illumination suitable e.g. for water disinfection.

According to a first aspect of the invention, this and other objects are achieved by a light-guiding member comprising a light transmissive, solid carrier material, and scattering particles of boron nitride dispersed in the carrier material. The content of the particles of boron nitride is in the range of from 0.001 to 5% by weight relative to the weight of the solid carrier material. The light-guiding member may comprise a light input surface and a light output surface. Typically, the light-guiding member is elongated and the light input surface is provided at or near an end of the light-guiding member.

By the term “light transmissive” is herein meant the physical property of allowing light to pass through a material. A light transmissive material can either be a material which is transparent, i.e. allowing light to pass through the material without being scattered, or a material which is translucent, i.e. allowing light to pass through the material with scattering an interface of the material and its surroundings where there is a difference in index of refraction, or at grain boundaries within the material (in the case of a polycrystalline material).

In embodiments of the invention, the light-guiding member is at least partially rod-shaped and comprises an envelope surface, wherein at least part of said envelope surface forms said light output surface.

In embodiments of the invention, the light transmissive solid carrier material is at least partially enclosed by a light transmissive encapsulant. Such an encapsulant may be a barrier layer or a water-tight and/or air-tight protective shell, protecting the carrier material from oxygen and/or water, thus preventing or at least reducing photodegradation of the carrier material. In these embodiments, an envelope surface of the solid carrier material may be directly covered by the encapsulant, such that light is transmitted from the carrier material into the encapsulant. An outer surface of the encapsulant may then form the light outcoupling surface of the light-guiding member.

The light transmissive solid carrier material may have a refractive index of at least 1.35, preferably at least 1.4. The carrier material comprises a polymer or a silicone-based material. The light transmissive solid carrier material may comprise a silicone derivative, such as a silicone resin, e.g. poly(dimethyl siloxane) (PDMS). The light-guiding member may have a content of particles of boron nitride in the range of from 0.002 to 0.5% by weight relative to the weight of the solid carrier material. The particles are typically mixed with the solid carrier material. The particles of boron nitride may have an average particle size in the range of from 0.5 to 10 μm. As used herein, the term “average particle size” refers to the standardized definition according to ASTM B330-12.

In some embodiments, the light-guiding member may further comprise scattering particles of aluminium oxide (Al₂O₃). The scattering particles of aluminium oxide may be present at a content in the range of from 0.001 to 5.0% by weight relative to the weight of the solid carrier material.

In another aspect, a light emitting arrangement is provided, comprising at least one solid state light emitting element, in particular an LED or a laser diode, and a light guiding member as described above, wherein said light-guiding member comprises a light input surface and a light output surface, and wherein the solid state light emitting element is arranged to emit light into the light guiding member via said light input surface, and light can be guided within the light-guiding member to be outcoupled via at least part of the light output surface.

Advantageously, due to the light-emitting arrangement may be only partially submersed in liquid such as water but may still provide enough light required for a photoreaction or for disinfection, such that the solid state light emitting element and electrical connections need not be submersed but thus may be kept dry above the liquid surface.

In embodiments where the light-guiding member comprises an encapsulant at least partially enclosing the carrier material, an outer surface of the encapsulant may form the light outcoupling surface.

The solid state light emitting element may be arranged on the light input surface of the light-guiding member. In embodiments of the invention, the solid state light emitting element may be adapted to emit light having a wavelength of 400 nm or less, e.g. 300 nm or less, although emission of longer wavelengths is also contemplated.

In yet another aspect, the invention provides a photo reactor comprising a reaction chamber and a light emitting arrangement as described above arranged to emit light into the reaction chamber, wherein said light-guiding member at least partially protrudes into the reaction chamber. The reaction chamber typically has a fluid inlet, for introduction of fluid to be treated or reacted into the reaction chamber, and a fluid outlet, for removing treated or reacted fluid from the reaction chamber. Advantageously, the light-emitting arrangement may be partially introduced into the reaction chamber and/or only partially submersed in liquid such as water, such that the solid state light emitting element and electrical connections need not be submersed but thus may be kept dry above the liquid surface.

In another aspect, a method of producing a light-guiding member is provided, comprising steps of

dispersing scattering particles of boron nitride in a light transmissive fluid carrier material to form a fluid composition;

optionally forming said fluid composition into a desired shape;

curing said fluid carrier material to provide a solid composition; and

optionally forming said solid composition into a desired shape.

Optionally, the fluid composition or the solid composition may be formed into a rod.

In some embodiments, the step of forming said fluid composition into a desired shape may involve applying said fluid composition into a glass container, which may function both as a mold and as a protective shell as described above.

The terms “UV light” “UV emission” or “UV wavelength range” especially relates to light having a wavelength in the range of about 200 nm-420 nm. UV light may be sub-divided into “UV-C light” that especially relates to light having a wavelength in the range of about 200 nm-280 nm, “UV-B light” that especially relates to light having a wavelength in the range of about 280 nm-315 nm and “UV-A light” that especially relates to light having a wavelength in the range of about 315 nm-420 nm

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a side view of a light emitting arrangement comprising a light-guiding member according to embodiments of the invention.

FIG. 2 shows a side view of a light emitting arrangement comprising a light-guiding member comprising an encapsulant according to embodiments of the invention.

FIG. 3 show photographs of tested light emitting arrangements comprising a 532 nm LED and different light-guiding members denoted PDMS-2 (reference), A-2 and F-2, respectively.

FIG. 4 show photographs tested light emitting arrangements including a 450 nm laser diode and different light-guiding members, denoted PDMS-1 (reference), A-1, B, C, D, E, and F-1, respectively.

FIG. 5 shows a photo reactor comprising a light emitting arrangement according to the invention.

FIG. 6 shows a side view of a light emitting arrangement comprising a light-guiding member comprising an encapsulant according to embodiments of the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

The inventors have found that an efficient, three-dimensional light-guiding body can be formed of a composite material comprising a light transmissive carrier material, typically a polymer matrix and a scattering material dispersed in the matrix. This is referred to as the light-guiding composition. Using a carrier material that is formable or deformable under certain conditions allows the composite material to be formed into any desired shape. Such a three-dimensional light-guiding body can be coupled to a light source to provide a light emitting body having a uniformly emitting surface. Such light emitting arrangements may be suitable for many different purposes, including UV disinfection.

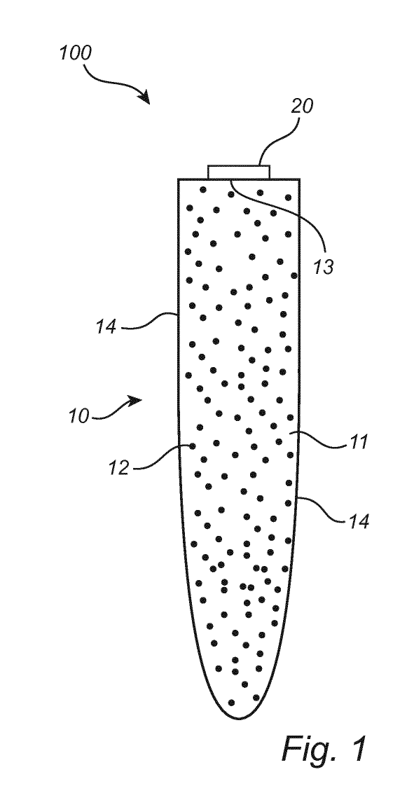

FIG. 1 shows a side view of a light emitting arrangement 100 comprising a light-guiding member 10 according to embodiments of the invention in the form of elongated member, having the shape of a rod or stick. A solid state light source, typically at least one light emitting diode (LED) 20 is arranged on a surface 13 of the light-guiding member 10, in this embodiment the short side of the rod-shaped member, formed of carrier material 11 and scattering particles 12. The light source 20 is arranged to emit light into the light-guiding member 10, thus the surface 13, which is flat, forms a light input surface. Light coupled into the light-guiding member 10 is guided within the light-guiding member and partially outcoupled, possibly uniformly, via a surface 14, which thus forms a light outcoupling surface. In this embodiment, the end of the rod-shaped member opposite to the surface 13 is rounded such that it forms part of a single envelope surface 14 of the light-guiding member 10; however it is envisaged that the end of a rod-shaped light-guiding member could have any suitable shape, including a flat end. The light-guiding member as such may also have any desired shape, for example a rod with any desired cross-sectional shapes, such as circular or polygonal (e.g. hexagon, octagon, or rectangle).

The light-guiding member comprises a light transmissive, solid carrier material and scattering particles dispersed within the carrier material.

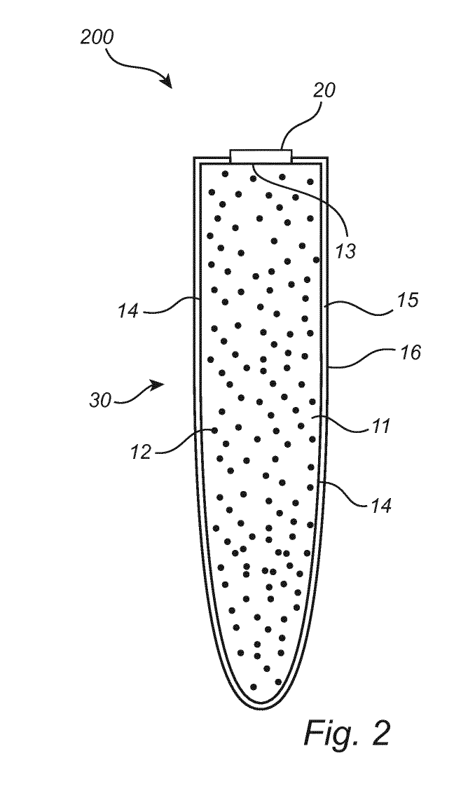

In embodiments of the invention, the carrier material may be impermeable to water. Alternatively or additionally, in an embodiment shown in FIG. 2, the carrier material 11 of a light-guiding member 30 may be encapsulated by an encapsulant 15, e.g. a barrier layer, or a protective shell, which may be air and/or liquid tight. Preventing or reducing the exposure to oxygen and/or water may prevent or reduce photoinduced oxidation and degradation of the carrier material 11. In such embodiments, light emitted from the LED 20 may be coupled into the guiding medium (the carrier material) through a window provided in the encapsulant 15. Alternatively, the LED 20 may also be encapsulated, together with the carrier material, by the barrier layer, allowing only electrical contacts for the LED to exit the enclosed package.

In embodiments comprising an encapsulant at least partially enclosing the carrier material, an envelope surface 14 of the solid carrier material may be directly covered by the encapsulant, such that light is transmitted from the carrier material into the encapsulant. An outer surface 16, typically an envelope surface, of the encapsulant 15 may then form the light outcoupling surface of the light-guiding member.

The encapsulant may have substantially the same shape as the solid carrier material. An encapsulant in the form of a protective shell may serve as a mould used for shaping the carrier material during manufacture of the light-guiding member.

Typically the carrier material comprises a curable polymer which may be mixed with scattering particles in a liquid or semi-liquid state, and subsequently cured to form a solid body. Curing may be performed stepwise, first to form a solid but deformable body that can be formed into the desired shape, optionally followed by a second curing step during which the material is completely solidified (so that it is no longer easily deformable). The curing may be performed under an inert atmosphere and may be preceded by a degassing step.

The carrier material should be at least partially transmissive to light of the wavelength range intended to be guided and spread by the light-guiding member, which may be light in the wavelength range of from 220 to 700 nm, such as from 240 to 400 nm or from 300 to 400 nm in the case of a UV emitting light source. In embodiments of the invention the carrier material may have a light transmission of at least 70% with respect to the relevant wavelength range.

The carrier material may have a refractive index higher than the refractive index of water (which is 1.35 at 285 nm), and preferably higher than the refractive index of any outer barrier layer, e.g. glass shell, that may enclose the carrier material. The refractive index of a barrier layer may for example be around 1.5 (e.g. 1.492 at 285 nm for fused silica).

Examples of suitable carrier materials are silicone-based materials, such as silicone resins (e.g. polydimethyl siloxane, PDMS).

The barrier layer, or the protective shell, may comprise a material selected from alumina, quartz glass, fused silica Pyrex® glass, or any glass material having a suitable transparency to light of the relevant wavelengths. In embodiments using a light source emitting light having a wavelength of less than 300 nm, the barrier layer or protective shell may especially be selected from quartz, fused silica. In embodiments using a light source emitting light having a wavelength of <320 nm, the barrier layer or protective shell Pyrex® glass may also be used, although quartz glass may still be preferable.

The scattering particles used in the present invention may be reflective microparticles or nanoparticles. For example, the particles may comprise particles of boron nitride and/or aluminum oxide, or other semiconductor materials having an energy band gap that is higher than the energy of the incident radiation. The particles may have an average particle size in the range of from 200 nm to 30 μm, for example from 500 nm to 10 μm. In some embodiments the light-guiding member may comprise particles of various sizes, for example a first population of scattering particles having an average particles size of 200 nm, and a second population of scattering particles having an average particles size of 1.0 μm.

The weight ratio of scattering particles to carrier material is in the range of from 0.001 to 5.0% (based on the weight of the carrier material). The weight ratio of scattering particles may be chosen based on the amount of light that is outcoupled from the light-guiding member, such that most photons are not absorbed through a high number of consecutive reflections within the light-guiding material.

The scattering particles may have a refractive index that is higher than the refractive index of the carrier material, and thus the scattering particles may contribute to increasing the refractive index of the light-guiding composition. For example particles of boron nitride may have a refractive index of 1.65, and particles of aluminum oxide (Al₂O₃) may have a refractive index of 1.77.

The refractive index of the light-guiding composition (including the carrier material and the scattering particles) may be at least 1.40, at least 1.45 or at least 1.50, depending on the refractive index of the surroundings during the intended use of the light-guiding member. For example, for a light-guiding member intended to be used in water (refractive index of 1.33), the light-guiding composition may have a refractive index of at least 1.40.

In embodiments where the light-guiding member comprises an encapsulant (a barrier layer or protective shell), the encapsulant is typically transparent to light of the relevant wavelength range, and has a refractive index equal to or lower than the refractive index of the light-guiding composition. Further, the refractive index of the encapsulant may be at least 1.35 or at least 1.45, depending on the refractive index of the surroundings during the intended use of the light-guiding member. For example, for a light-guiding member intended to be used in water (refractive index of 1.33), the encapsulant may have a refractive index of at least 1.40 and the light-guiding composition may have a refractive index that is equal to or higher than the refractive index of the encapsulant.

The present invention may be used as a portable device, e.g. a “UV light pen” for sterilization or disinfection of fluids, such as air or water. It may also be used for guiding and transporting light into or within a photoreactor in order to initiate or trigger a photo-chemical reaction of reactants in liquid and/or gaseous phase. A light emitting arrangement for example such as the one illustrated in FIG. 1 may be partially immersed into a liquid during operation of the light source such that UV light is spread via the light-guiding member into the liquid. Advantageously, the light source, which may be arranged on a short end of the light-guiding member, need not be immersed into liquid, which increases user safety and also protects the light source from damage.

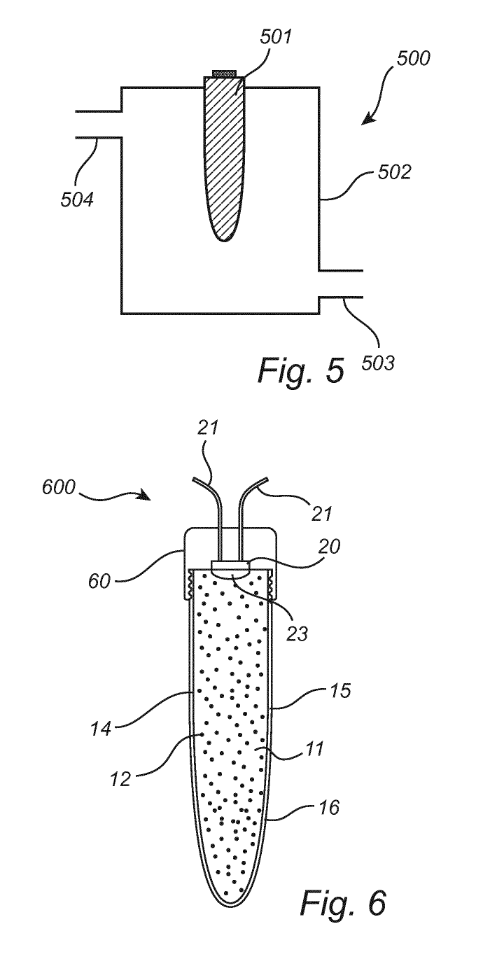

FIG. 5 shows an embodiment of a photo reactor 500 comprising a light emitting arrangement 501 according to the invention. The photo reactor 500 may be used, for example, for the disinfection of water or air. The photo reactor 500 has a chamber 502 in which the light emitting arrangement 501 is placed. The light emitting arrangement 501 may be a light emitting arrangement as shown in FIG. 1 or, alternatively, as shown in FIG. 2 or in FIG. 6. The fluid enters the chamber 502 via an inlet 503 and exits the chamber 502 via an outlet 504. The UV light that is generated by the light emitting arrangement 501 during operation of the photo reactor 500 is used for disinfecting the fluid that flows though the chamber 502.

FIG. 6 shows another embodiment of the invention, represented by a light emitting arrangement 600 comprising a rod-shaped light-guiding member substantially as described above, comprising scattering particles 12 dispersed in a carrier material 11. The envelope surface 14 formed by the carrier material is covered by an encapsulant 15. An LED 20 is arranged to emit light into the light-guiding member, via an optical element 23. In this figure, contacts 21 for connecting the LED 20 to a driver are also shown. The contacts 21 may also represent a battery. A cap 60 is arranged over the top end of the light-guiding member, including the LED 20 and parts of the contacts 21. The contacts 21 are allowed to pass through the cap. The cap may be air-tight and/or liquid tight, and may be fitted by means of screwing. Advantageously, the cap 60 can prevent oxygen and/or water from contacting the carrier material via the top surface (light input surface) of the light-guiding member, and may hence further reduce photo induced degradation of the carrier material.

### Examples

Six different light-guiding compositions according to embodiments of the invention were produced by dispersion various amounts (see Table 1 below) of reflective particles of either boron nitride (BN) or alumina (Al₂O₃) into a PDMS matrix.

TABLE 1

| Light-guiding | Reflective particle | |
|---|---|---|
| composition | BN | Al₂O₃ |
| A-1, A-2 | 0.002 wt % | — |
| B | 0.03 wt % | — |
| C | 0.1 wt % | — |
| D | 0.5 wt % | — |
| E | — | 0.05 wt % |
| F-1, F-2 | — | 0.5 wt % |

Each composition was prepared by mixing liquid PDMS base and crosslinking agent (10:1 weight ratio) (Sylgard 184, DOW Corning) with the given amount of BN particles or Al₂O₃ particles. To test the influence of the concentration, all BN particles used in this experiment had the same diameter, 1.0 μm, and were purchased from Sigma-Aldrich.

The compositions were filled into respective 8 cm glass tubes (Pyrex®) and cured at room temperature for 24 hours.

After curing, each light-guiding member thus formed was coupled to a light source outlined in Table 2 below.

TABLE 2

| Light-guiding | |
|---|---|
| composition/member | Light source |
| A-1 | 450 nm laser diode |
| A-2 | 532 nm LED |
| B | 450 nm laser diode |
| C | 450 nm laser diode |
| D | 450 nm laser diode |
| E | 450 nm laser diode |
| F-1 | 450 nm laser diode |
| F-2 | 532 nm LED |

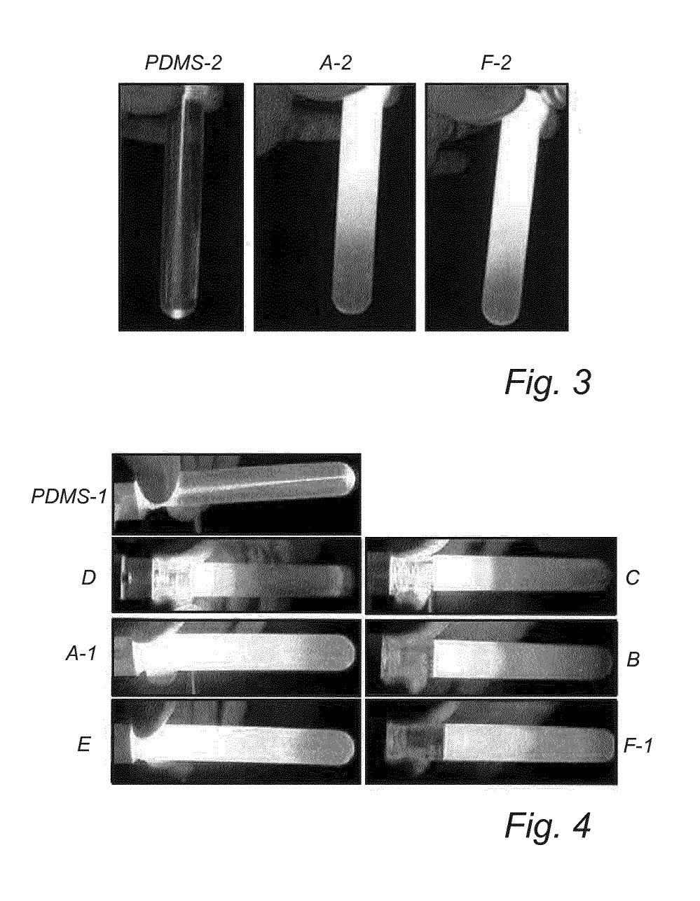

For comparison, two glass tubes were filled with clear PDMS (without particles), denoted “PDMS” and coupled to a 450 nm or 532 nm light source, respectively. FIGS. 3 and 4 show photographs of the tested light guiding members and the references PDMS-1 and PDMS-2. It was seen that at lower concentrations of scattering particles, the light traveled further towards the end of the tube. In the PDMS tubes, a thin, straight trace of light was visible due to small scattering point in the material (air bubbles, impurities or the like).

The person skilled in the art realizes that the present invention by no means is limited to the preferred embodiments described above. On the contrary, many modifications and variations are possible within the scope of the appended claims. For example, although the invention has been described in connection with a UV light source, it is conceivable to use the light-guiding member with a solid state light source adapted to emit light having a wavelength in the range up to 700 nm or even 800 nm. Such devices may be useful in various photoreactors or other applications.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A light-guiding member comprising a light transmissive, solid carrier material, and scattering particles of boron nitride dispersed in said carrier material wherein the content of said particles of boron nitride is in the range of from 0.001 to 5% by weight relative to the weight of the solid carrier material.

2. A light-guiding member according to claim 1, wherein said light-guiding member comprises a light input surface and a light output surface.

3. A light-guiding member according to claim 1, wherein the light transmissive solid carrier material is at least partially enclosed by a light transmissive encapsulant.

4. A light-guiding member according to claim 1, wherein said light transmissive solid carrier material has a refractive index of at least 1.35, preferably at least 1.4.

5. A light-guiding member according to claim 1, wherein said light transmissive solid carrier material comprises a polymer or a silicone-based material.

6. A light-guiding member according to claim 1, wherein said light transmissive solid carrier material comprises a silicone derivative.

7. A light-guiding member according to claim 1, wherein said particles of boron nitride have an average particle size in the range of from 0.5 to 10 μm.

8. A light-guiding member according to claim 1, having a content of said particles of boron nitride in the range of from 0.002 to 0.5% by weight relative to the weight of the solid carrier material.

9. A light-guiding member according to claim 1, further comprising scattering particles of aluminium oxide (Al₂O₃).

10. A light emitting arrangement comprising a solid state light emitting element and a light guiding member according to claim 1, wherein said light-guiding member comprises a light input surface and a light output surface, and wherein the solid state light emitting element is arranged to emit light into the light guiding member via said light input surface, and light can be guided within the light-guiding member to be outcoupled via at least part of the light output surface.

11. A light emitting arrangement according to claim 10, wherein said solid state light emitting element is arranged on said light input surface of the light-guiding member.

12. A light emitting arrangement according to claim 10, wherein said solid state light emitting element is adapted to emit light having a wavelength of 400 nm or less.

13. A photo reactor comprising a reaction chamber and a light emitting arrangement according to claim 10 provided to emit light into the reaction chamber, wherein said light-guiding member at least partially protrudes into the reaction chamber.

14. A method of producing a light-guiding member according to claim 1, comprising steps of
dispersing scattering particles of boron nitride in a light transmissive fluid carrier material to form a fluid composition;
optionally forming said fluid composition into a desired shape;
curing said fluid carrier material to provide a solid composition, wherein the content of said particles of boron nitride is in the range of from 0.001 to 5% by weight relative to the weight of the solid carrier material; and
optionally forming said solid composition into a desired shape.

15. A method according to claim 14, wherein said step of forming said composition into a desired shape involves applying said fluid composition into a glass container.
